(19) United States
(12) Patent Application Publication
(10) Pub. No.: US 2003/0069995 A1
(43) Pub. Date: Apr. 10, 2003

(54) Method and system for communicating among heterogeneous systems

(76) Inventor: Brad K. Fayette, Wake Forest, NC (US)

Correspondence Address: BAKER & BOTTS, 30 ROCKEFELLER PLAZA, NEW YORK, NY, 10112

(21) Appl. No.: 09/972,568

(22) Filed: Oct. 5, 2001

(51) Int. Cl. G06F 15/16

(52) U.S. Cl. 709/249; 709/245

(57) ABSTRACT

A method and system for communication among heterogeneous systems is provided including a stateless protocol method for encapsulating communication information according to a legacy protocol common to sending and receiving systems and providing a scheme for interpreting received communication information consistent with the legacy protocol while providing for upgraded versions of the legacy protocol to be utilized.

### FIELD OF THE INVENTION

This invention relates to methods and systems for communication among heterogeneous communications systems.

### BACKGROUND OF THE INVENTION

In network based systems, it is known to provide for communicating a message from one system to another, each having disparate communication protocols, by encoding and decoding of the message as it passes from one layer to another. Encoding generally adds or removes header information. A header can include information related to the routing of the message, such as destination port or address of the message, the origin address of the message, and other things. For example, http, TCP, IP, PPP all represent differing layers of communications protocols and can form a protocol stack of encoded information for a particular message. For example, as a message is passed down to lower layers—from http to TCP, from TCP to IP, or from IP to PPP—the message being sent is encapsulated with additional protocol information.

Protocols at higher levels are occasionally upgraded and additional information can then be added to a header. Thus, when an upper layer protocol used by a sending machine changes, a receiving machine may not be able to successfully decode the message since the receiving machine may not have received updated decoding information for decoding the message according to the updated protocol.

### SUMMARY OF THE INVENTION

A method and system of communications between heterogeneous systems is described for which embodiments can be provided which are efficient, lightweight, upgradeable, machine independent and provide for backward compatibility. One embodiment of the method according to the invention describes a stateless protocol method for communicating between software processes in the same or different computing platforms and provides for layered protocols. The method implemented on each platform can permit each platform to convert received data from the format defined for a predetermined type to a format which is convenient to the receiving platform.

The stateless protocol method and system is operable on a computer processor and computer memory and can comprise a computer program which configures the computer processor to establish a legacy protocol which defines legacy parameters for a header portion of a message and defines a fixed legacy message length. The stateless protocol method and system can receive an inbound message having a data portion and allocate a memory stack from the computer memory having a depth corresponding to the fixed legacy message length. The stateless protocol method and system pushes the inbound message onto the memory stack such that the data portion is pushed onto said stack first. After this, the stateless protocol method and system can interpret the portion of the inbound message in the stack according to the legacy protocol.

In another embodiment of the stateless protocol method and system, the computer program configures the computer processor to establish an upgraded protocol which defines upgraded header parameters that follow the legacy parameters. In addition, the upgraded protocol defines a fixed upgraded message length provides for a memory stack having a depth corresponding to said the message length. The stateless protocol method and system can interpret the inbound message according to the upgraded protocol or the legacy protocol. In another embodiment, the stateless protocol method and system can be further provided to pad the memory stack with default padding values when the inbound message does not fill the memory stack.

In addition, the stateless protocol method and system can be provided to construct a legacy header according to the legacy protocol and to append the legacy header to outbound data and thereby create an outbound message having the fixed legacy message length which can then be sent. Alternatively, the stateless protocol method and system can be further provided to establish an upgraded protocol and to construct an upgraded header according to the upgraded protocol which can be used to create the outbound message.

### BRIEF DESCRIPTION OF THE DRAWINGS

FIG. 1 is a block diagram of a network utilizing an embodiment of a stateless protocol communications system according to the invention;

FIG. 2 is a block diagram of a system for implementing an embodiment of the a stateless protocol communications system according to the invention;

FIG. 3 is a flowchart of an embodiment of the stateless protocol method according to the invention;

FIG. 4 is a is a flowchart of an embodiment of the stateless protocol method according to the invention; and

FIG. 5 is a is a flowchart of an embodiment of the stateless protocol method according to the invention.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION

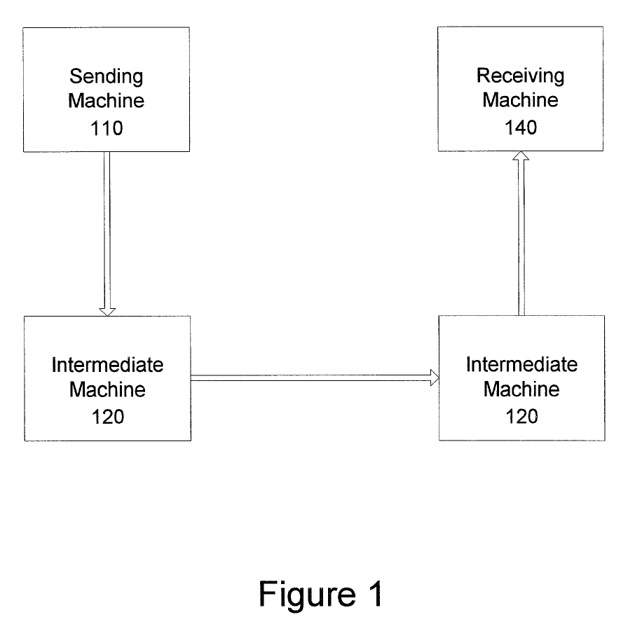

FIG. 1 is an illustration of a network communication system in which an embodiment of a stateless protocol system and method according to the invention can be used. In the illustrated communications system, a sending machine 110 seeks to send a message to a receiving machine 140 via a network including any number of intermediate machines 120 and a number of intervening links. It can be appreciated that at least two of the machines in the network, the sending the machine 110 and the receiving machine 140, are provided with an embodiment of the stateless protocol communications system. It can also be appreciated that a machine can function both as a sending machine 110 and a receiving machine 140. Intervening links can be any form of communications means between one machine and another, such as electrical, optical, or microwave and can have different formats or protocols such as IP, Ethernet, or serial links among others.

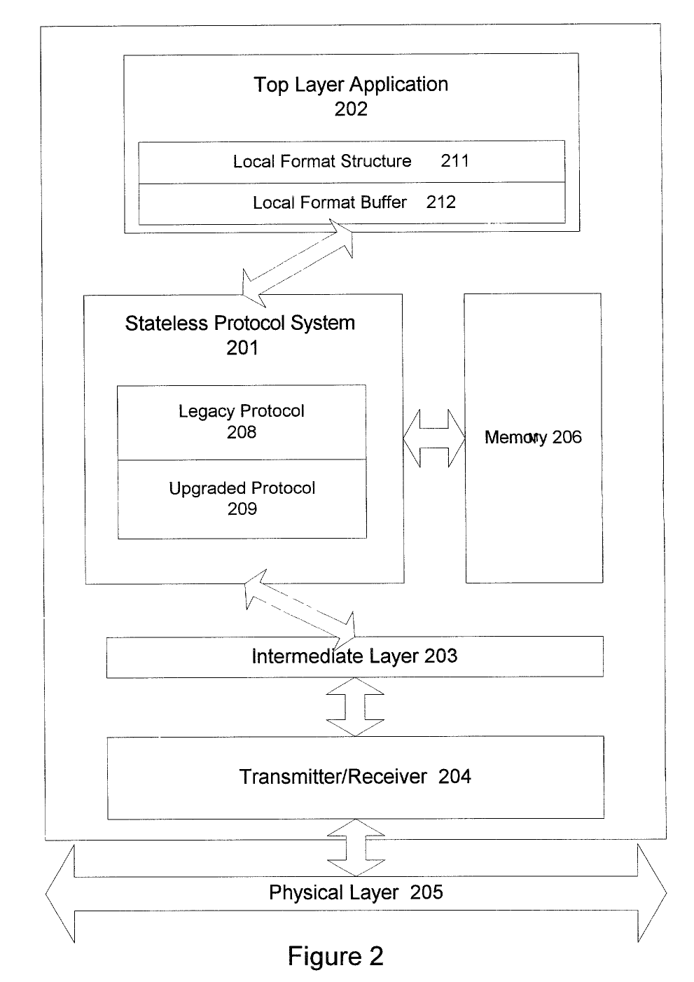

FIG. 2 is an illustration of a machine having an embodiment of the stateless protocol system 201 according to the invention. The machine can be a computer having a top layer application 202 which provides an interface for communicating over a network. The top layer application generally has a local data structure 211 for defining data according to a local format. Data manipulated by the top layer application 202 can be stored in a local buffer 212 memory device according the local format. The stateless protocol system 201 is provided in communication with the top layer application 202 and provides for conversion of data according to a protocol established by the stateless protocol system 201. The stateless protocol system 201 is provided with a legacy protocol 208 and can also include an upgraded protocol 209 which can be provided in addition to or in place of the legacy protocol 208. The legacy protocol 208 and upgraded protocol 209 define formats for header information in the form of parameters which can provide communication information related to data being sent from one system to another, among other things. The legacy protocol 208 and upgraded protocol 209 can be stored in the memory or otherwise programmed into the stateless protocol system 201 as software or hard coded into logic circuits.

The stateless protocol system 201 can be provided with a storage device such as computer memory for temporary storage of data and for facilitating the manipulation of data. The storage device can be provided as a memory 206 which can be provided as a memory buffer or memory stack among other things. Alternatively, the storage device can be provided separate from the stateless protocol system 201 with a communications link to provide the stateless protocol system 201 with access to the storage device. It can be appreciated that a storage device can be any means which provides for storage of information such as computer memory, magnetic storage media among other things.

The stateless protocol system 201 can communicate with other machines directly or though an intermediate layer 203. A transmitter and/or receiver 204 can be provided in a machine having an embodiment of the stateless protocol system 201 for communicating with other machines through a physical layer 205.

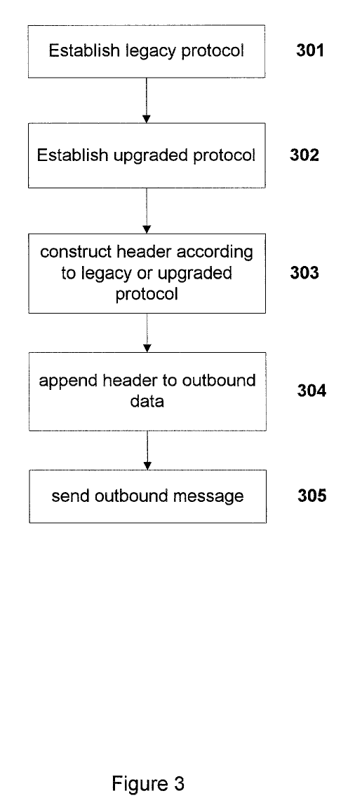

FIG. 3 is an illustration of an embodiment of the stateless protocol method. The method can be provided as an software or it can be hard coded into logic circuits of a system. The stateless protocol method establishes (step 301) a legacy protocol 208 by creating a format for a fixed length header as a combination of several parameters. It can be appreciated that establishing (step 301) a legacy protocol 208 can be done by direct user programming or it can use automation to build a format based on local information or information obtained from other machines. The legacy protocol 208 that is established is initially provided to all instances of the stateless protocol method to be used by upper level machines in the network, such as the sending machine 110 and the receiving machine 140. In this manner, both the sending machine 110 and the receiving machine 140 are provided with a common understanding of the set of legacy parameters that make up a fixed length header according to the protocol.

The legacy protocol can comprise one or more groups of parameters which when taken together comprise a fixed length header. Each parameter comprises a type and value pair, represented in this example as {type} and {value}, and when provided in combination can be used to define a fixed length header according to one embodiment of the invention. The “type” parameter is used to indicate the kind of data being pushed, such as an integer or a string. The “value” parameter is used to represent at least a portion of the parameter information to be sent and is characterized by the indicated type. Each instance of the stateless protocol method implemented by the machines on the network is provided with a common definition for each type of data being sent. For example, where the protocol defines a type of “1” to be an integer, each implementation of the process is provided with a common definition of a type “1” indicating an integer. Similarly, an additional type of “2” can be commonly understood to indicate a string having a predefined length. The stateless protocol method can set a flag or null value, such as “0”, to represent the absence of data rather than a type of data. Other types can be provided, such as boolean which can be provided in addition to, or instead of the integer or string types. In alternate embodiments of the stateless protocol according to the invention, several groupings of parameters can be used to form a fixed length header, wherein each group can have a differing or a same number of parameters.

The stateless protocol method can also establish an upgraded protocol (step 302) in an alternative embodiment. To establish an upgraded protocol, a set of parameters according to the legacy protocol are taken as a base of the header and then additional upgraded parameters for an upgraded version are appended to the legacy parameters. The additional parameters can be added to the end of the header away from the message according to the particular implementation of the protocol.

For example, data or message information to be sent by a user from a top layer application 202 can be initially stored in a local buffer 212 or memory of a sending machine 110 and can be represented by a series of bits according to the local format structure 211 known to the top layer application 202. When such outbound data is received by the stateless protocol method implemented on the sending machine 110, the stateless protocol method constructs (step 303) a header having a predetermined length according to the existing protocol. As mentioned, the fixed length header can provide addressing information for a receiving machine 140 to interpret among other things. The header and data can then be sent as one or more message packets, each comprising at least a portion of the data and header, to a receiving machine 110.

The stateless protocol method implemented on the sending machine 110 constructs (step 303) a header intended for the receiving machine 140 based upon the fixed length header format defined by the legacy protocol 208. Alternatively, the header can be constructed according to the upgraded protocol 209. Once the header is created by the stateless protocol of the sending machine 110, the header is appended (step 304) to one end of the data to be sent. Assuming, for point of example, that a {type} of {1} indicates that the {value} parameter is a string. Thus, the parameter comprising the message provided is string information can be represented as {a, b, c, d, 1} where the parameter is comprised of a {value}, such as a string {a, b, c, d}, and then followed by a {type}.

It can be understood that it is an alternate embodiment, the order of type and value is a parameter can be reversed and that the order in which each parameter is constructed depends upon the particular implementation of the stateless protocol system. Similarly, it can be understood that the ordering of the constructed message depends upon the particular implementation of communication protocol implemented by the system. One implementation of the stateless protocol can provide that the header intended for the receiving machine 140 be placed at a end of the message or data and is sent after the message. This can be done so that the header intended for the receiving machine 140 can be placed in a fixed sized receiving stack of the receiving machine 140 after the body of the message has been placed in the stack. In so doing, one implementation of the stateless protocol can provide that only the message and the fixed length header as understood by the protocol of the receiving machine 140 are placed in the stack and newer protocol information is removed if such information cannot be accommodated by the protocol existing on the receiving machine 140. It can be appreciated that alternative embodiments of the protocol can be employed to the same effect. For example, a computer or software of the receiving machine can be programmed to interpret only that portion of a header consistent with the protocol of the receiving machine 140.

In addition, it can be understood that additional information may need be shared among communicating machines in order to ensure proper transmission and receipt of information. One such consideration is whether the number being sent in binary form is sent having its least significant bits sent first or whether the number is sent having its most significant bits sent first. Therefore, an additional designation of data format may need to be provided. One solution would be to provide that a designation of format is sent before any data in a different format so that any reformatting of the data can be provided as necessary to ensure the proper interpretation of the data upon receipt.

Once a message and header are constructed, the sending machine 110 sends (step 305) the outbound data and header as an outbound message to an intermediate machine 120 or receiving machine 140. Again, depending upon the communication protocol chosen, bits representing the value, i.e. {a, b, c, d} for a string, can be sent first, and bits representing the type information, i.e. {1} in the example can be sent after.

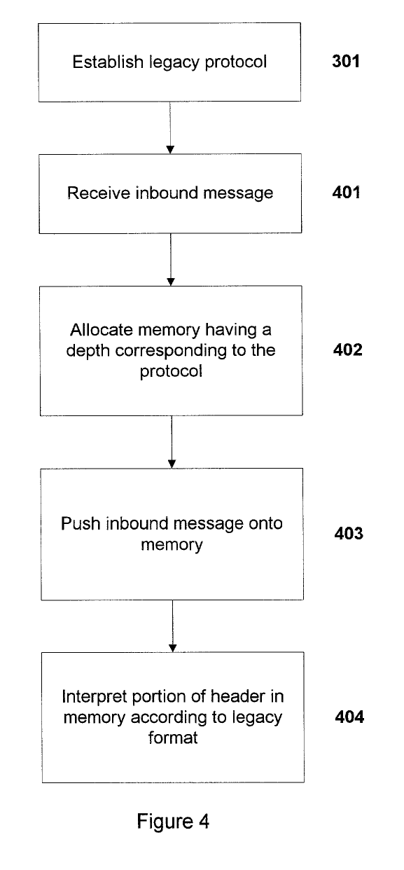

FIG. 4 shows another embodiment of the stateless protocol method according to the invention. When a receiving machine 140 having a version of the stateless protocol method receives an inbound message (step 401), it can first strip the message of any additional header information associated with intermediate communication protocols of intermediate machines 120. It is believed that intermediate communication protocols between adjacent machines can provide header information including the length of the message being communicated.

In one embodiment of the stateless protocol method implemented on the receiving machine 140, each piece of data of the message packet is pushed (step 403) into in the memory 206 according to the order in which the data was received. Pushing data (step 403) on a memory 206 can have affect of flattening the data. Thus, the data received first, “a”, is placed at the bottom of the memory 206 and data received later, such as “d”, is stored closer to the top of the memory 206. As a result any additional header information, such as may be added by an upgraded version of the stateless protocol, is removed to prevent confusion when such a message is received by a machine having the legacy protocol 208. It can be appreciated by one of ordinary skill in the art, that other methods of manipulating the received data can be employed to the same effect without departing from the spirit of the invention.

Since the sending machine 110 and receiving machine 140 share a common legacy version of the stateless protocol, the receiving machine 140 expects a message and header of a known length and can allocate a memory 206 of a corresponding depth for receiving the message or specifically for the header. If the receiving machine 140 expects to receive the same fixed format header as that which was sent by the sending machine 110, the length of the message and header received by receiving machine 140 matches the size of the memory 206 or stacks allocated by the stateless protocol implemented on the receiving machine 140. As mentioned previously, this result can be effected by only interpreting that portion of the header that is consistent with the protocol on the receiving machine 140. After the data has been pushed onto the memory 206, the stateless protocol system can interpret (step 404) the data according to the version of the protocol on that machine.

The stateless protocol method permits a machine to upgrade its protocol from a legacy version of the stateless protocol to an upgraded version. In addition the stateless protocol method also permits further upgrades from previous upgraded protocols 209. In order to ensure that a receiving machine 140 can understand a header created by either the legacy protocol 208 or the upgraded protocol 209, the stateless protocol system and method may only upgrade a header in a consistent manner. For example, in establishing (step 302) an upgraded protocol 209, the parameters of the existing protocol are continued to be used in forming a header of a message and only additional data items are appended to the existing protocol. Furthermore, any additional parameters can be prepended to the legacy header 208 at the end of the header and away from the message. For example, a sending machine 110, can provide an additional parameter, such as having {type}of {2}, which can represent an integer having a {value} of {3}. Thus, the upgraded header having two parameters can be represented as {3, 2, a, b, c, d, 1}.

A receiving machine 140 having a legacy version of the stateless protocol can interpret a received message having an upgraded header. The receiving machine 140 expects to receive a message and header of a length set by the legacy format and allocates a memory or stack of corresponding depth. For example, when the receiving machine 140 receives a message, such as {3, 2, a, b, c, d, 1}, the message and header are added to the memory 206 first, and then are followed by the header. Since the memory 206 has been allocated only sufficient storage space for {a, b, c, d, 1} according to the legacy protocol 208, additional parameters of the upgraded header can be stripped off or ignored and the header becomes truncated or flattened. Thus, the parameters {3, 2} provided by the upgraded protocol 209 can be dropped because the memory has become occupied by the legacy protocol 208 which proceeded it. As mentioned, the legacy protocol may use default values instead of the data {3,2] sent by the system having the upgraded protocol. It can be appreciated that other methods of stripping the upgraded protocol information can be implemented without departing from the scope of the invention.

Thus, the pushing of data onto memory of a size determined by a legacy protocol 208 at a receiving machine 140 causes the message to be flattened by the memory 206 and thereby preserves only that information understood by the receiving machine 140 having the legacy format of the stateless protocol. As a consequence, the format of the header of sending machine 110 can be upgraded without disturbing the communications to other machines having an earlier version of the stateless protocol implemented in their systems.

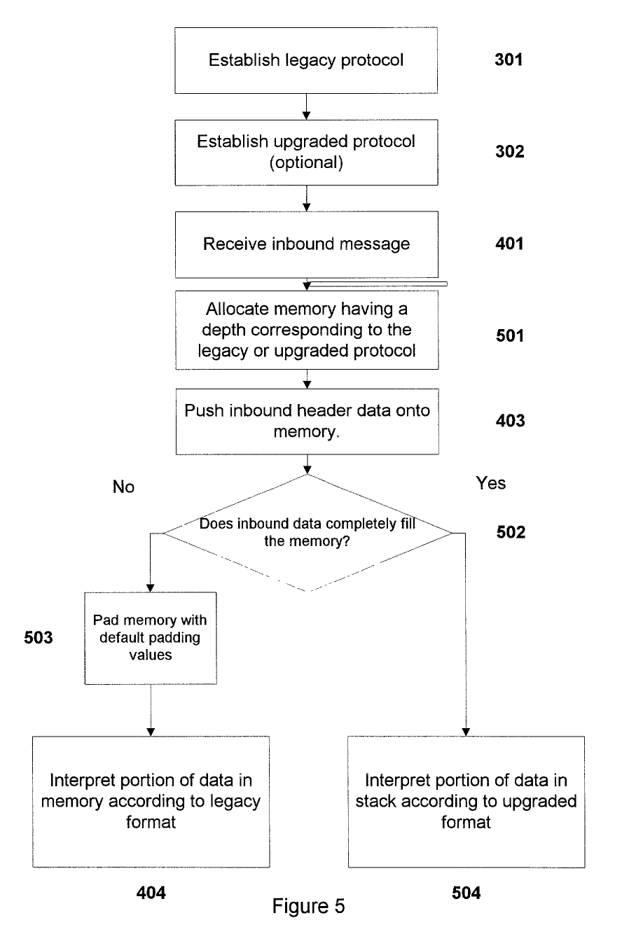

The flexibility of the stateless protocol method is also apparent in an alternative situation when a receiving machine 140 has an upgraded protocol 209 and receives a message having a header according to the legacy protocol 208. FIG. 5 illustrates another embodiment of the stateless protocol method according to the invention. For example, a receiving machine 140 having upgraded the fixed header of the legacy protocol 208 to include additional data items such as {3, 2}, can allocate (step 501) a memory 206 having depth corresponding to the size of the upgraded protocol 209.

When the receiving machine 140 receives a message from a sending machine 110 having a legacy header, the memory 206 or stack of the receiving machine 140 has room to spare in its allocated memory 206 to accommodate the message and legacy header. The stateless protocol method can be provided with an optional check (step 505) to determine whether the memory has been filed. When there is room to spare in the memory 206, any unfilled portion of the memory can be padded (step 503) with default padding values, such as null values. Accordingly, a memory 206 of the receiving machine 140 that has received a message in the legacy format, can have data in the memory such as {0, 0, a, b, c, d, 1}. The stateless protocol method and system can be provided to disregard the padding data when interpreting (step 404) the header and message according to the existing version of the protocol. Otherwise, when a message having the upgraded protocol 209 is received, the stateless protocol method can interpret (step 504) the header and message according to the upgraded protocol 209.

Once a machine upgrades its version of the protocol, the changes to the protocol can be distributed to other machines in the network to allow the other machines to use the addition protocol parameters. It can be appreciated that upgraded versions of the stateless protocol method can be distributed among machines by conventional techniques, such as multicasting or broadcasting, in order to provide each machine with an upgraded version of the stateless protocol method. However, when two machines have upgraded their existing versions of the protocol and have not yet forwarded the changes to each other, confusion can result where each allocates a deeper memory or stack and receives additional information which may not be consistent. Under such circumstances, the receiving machine 140 can choose to interpret the message according to the legacy protocol 208. Once all machines in a common communications network receive a common version of an upgraded protocol 209, that upgraded protocol 209 can be considered to be a new legacy protocol 208 among the machines of that network.

Although the present invention has been described in connection with specific exemplary embodiments, it should be understood that various changes, substitutions and alterations can be made to the disclosed embodiments without departing from the spirit and scope of the invention as set forth in the appended claims.

I claim:

1. A stateless protocol method which is operable on a computer processor and computer memory, the stateless protocol comprising a computer program which configures the computer processor to:
establish a legacy protocol, wherein said legacy protocol defines at least one legacy parameter for a header portion of a message, and wherein said legacy protocol defines a fixed legacy header length;
receive an inbound message having a header portion;
allocate a memory portion from the computer memory, said memory portion having a depth corresponding to said fixed legacy header length;
push said header portion of said inbound message onto said memory portion thereby forming a received header; and
interpret said received header according to said legacy protocol.

2. The stateless protocol method according to claim 1, further comprising a computer program which configures the computer processor to:
establish an upgraded protocol, wherein said upgraded protocol includes said at least one legacy parameter of said legacy protocol, wherein said upgraded protocol defines at least one upgraded header parameter for said header portion, and wherein said upgraded protocol defines a fixed upgraded header length;
wherein said memory portion has a depth corresponding to said upgraded header length;
wherein said received header of said inbound message is interpreted according to said upgraded protocol if at least one upgraded header parameter is pushed on the memory portion; and
wherein said received header of said inbound message is interpreted according to said legacy protocol when no upgraded header parameters are pushed on the memory portion.

3. The stateless protocol method according to claim 2 further comprising a computer program which configures the computer processor to:
pad said memory portion with default padding values when said header portion of said inbound message does not fill said memory portion.

4. The stateless protocol method according to claim 1, wherein said legacy parameter comprises a value-type pair.

5. The stateless protocol method according to claim 1, wherein said inbound message includes a data portion and wherein said header portion is pushed onto said memory portion after said data portion.

6. A stateless protocol method which is operable on a computer processor and computer memory, the stateless protocol comprising a computer program which configures the computer processor to:
establish a legacy protocol, wherein said legacy protocol defines at least one legacy parameter for a header portion of a message, and wherein said legacy protocol defines a fixed legacy header length;
construct a legacy header according to said legacy protocol;
append said legacy header to outbound data thereby creating an outbound message; and
send said outbound message.

7. The stateless protocol method according to claim 6, further comprising a computer program which configures the computer processor to:
establish an upgraded protocol, wherein said upgraded protocol includes said at least one legacy parameter of said legacy protocol, wherein said upgraded protocol defines at least one upgraded header parameter, and wherein said upgraded protocol defines a fixed upgraded header length;
construct an upgraded header according to said upgraded protocol; and
append said upgraded header to outbound data.

8. The stateless protocol method according to claim 7 wherein the computer program configures the computer processor to append said upgraded header to outbound data wherein said at least one legacy parameter is proximate to said outbound data.

9. The stateless protocol method according to claim 6 wherein said legacy parameter comprises a value-type pair.

10. The stateless protocol method according to claim 7, wherein said inbound message includes a data portion, and wherein said header portion is pushed onto said memory portion after said data portion.

11. A stateless protocol method which is operable on a computer processor and computer memory, the stateless protocol comprising a computer program which configures the computer processor to:
establish a legacy protocol, wherein said legacy protocol defines at least one legacy parameter for a header portion of a message, and wherein said legacy protocol defines a fixed legacy header length;
receive an inbound message having a header portion;
allocate a memory portion from the computer memory, said memory portion having a depth corresponding to said fixed legacy header length;
push said header portion of said inbound message onto said memory portion thereby forming a received header;
interpret said received header according to said legacy protocol;
construct a legacy header according to said legacy protocol;
append said legacy header to outbound data thereby creating an outbound message; and
send said outbound message.

12. The stateless protocol method according to claim 11, further comprising a computer program which configures the computer processor to:
establish an upgraded protocol, wherein said upgraded protocol includes said at least one legacy parameter of said legacy protocol, wherein said upgraded protocol defines at least one upgraded header parameter, and wherein said upgraded protocol defines a fixed upgraded header length;
wherein said memory portion has a depth corresponding to said upgraded header length;
wherein said received header of said inbound message is interpreted according to said upgraded protocol if at least one upgraded header parameter is pushed on the memory stack;
wherein said received header of said inbound message is interpreted according to said legacy protocol if no upgraded header parameters are pushed on the memory stack;
construct an upgraded header according to said upgraded protocol; and
append said upgraded header to outbound data.

13. The stateless protocol method according to claim 11 further comprising a computer program which configures the computer processor to push said legacy parameter onto said memory portion before said upgraded parameter is pushed onto said memory portion.

14. The stateless protocol method according to claim 11 further comprising a computer program which configures the computer processor to:
receive said inbound message from an upper layer application having a header portion in an upper layer format; and
send said outbound message to a lower layer application.

15. A stateless protocol system for processing at least one inbound message, the system comprising:
a computer memory, and
a computer processor, said processor being programmed to
establish a legacy protocol, wherein said legacy protocol defines at least one legacy parameter for a header portion of a message, and wherein said legacy protocol defines a fixed legacy header length;
allocate a memory portion from the computer memory, said memory portion having a depth corresponding to said fixed legacy header length;
push said header portion of said inbound message onto said memory portion wherein said data portion is pushed onto said stack first; and
interpret said received header according to said legacy protocol.

16. The stateless protocol system according to claim 15, wherein said processor is further programmed to:
establish an upgraded protocol, wherein said upgraded protocol includes said at least one legacy parameters of said legacy protocol, wherein said upgraded protocol defines at least one upgraded header parameter, and wherein said upgraded protocol defines a fixed upgraded header length;
wherein said memory portion has a depth corresponding to said upgraded header length;
wherein said portion of said message is interpreted according to said upgraded protocol if at least one upgraded header parameter is pushed onto said memory portion; and
wherein said portion of said message is interpreted according to said legacy protocol if no upgraded header parameters are pushed onto said memory portion.

17. The stateless protocol system according to claim 16 wherein said processor is further programmed to pad said memory portion with default padding values when said message does not fill said memory portion.

18. A stateless protocol system for processing at least one outbound message, the system comprising:
a computer memory; and
a computer processor, said processor being programmed to establish a legacy protocol, wherein said legacy protocol defines at least one legacy parameter for a header portion of a message, and wherein said legacy protocol defines a fixed legacy header length;
construct a legacy header according to said legacy protocol;
append said legacy header to outbound data thereby creating an outbound message having said fixed legacy message length; and
send said outbound message.

19. The stateless protocol system according to claim 18, wherein said processor is further programmed to:
establish an upgraded protocol, wherein said upgraded protocol includes said at least one legacy parameter of said legacy protocol, wherein said upgraded protocol defines at least one upgraded header parameter, and wherein said upgraded protocol defines a fixed upgraded message length;
construct an upgraded header according to said upgraded protocol; and
append said upgraded header to outbound data, thereby creating an outbound message of said fixed upgraded message length.

20. A stateless protocol system for processing inbound and outbound messages, the system comprising:
a computer memory; and
a computer processor, said processor being programmed to
establish a legacy protocol, wherein said legacy protocol defines at least one legacy parameter for a header portion of inbound and outbound messages, and wherein said legacy protocol defines a fixed legacy message length;
receive an inbound message having a data portion;
allocate a memory stack from said computer memory, said memory stack having a depth corresponding to said fixed legacy message length;
push said inbound message onto said memory stack thereby forming at least a portion of said inbound message, wherein said data portion is pushed onto said stack proximate to a bottom of said stack;
interpret said portion of said inbound message according to said legacy protocol;
construct a legacy header according to said legacy protocol;
append said legacy header to outbound data thereby creating an outbound message of said fixed legacy message length; and
send said outbound message.

21. The stateless protocol system according to claim 20, wherein said processor is further programmed to:
establish an upgraded protocol, wherein said upgraded protocol includes said at least one legacy parameter of said legacy protocol, wherein said upgraded protocol defines at least one upgraded header parameter, and wherein said upgraded protocol defines a fixed upgraded message length;
wherein said memory stack has a depth corresponding to said upgraded message length;
wherein said portion of said inbound message is interpreted according to said upgraded protocol if at least one upgraded header parameter is pushed onto said memory stack;
wherein said portion of said inbound message is interpreted according to said legacy protocol if no upgraded header parameters are pushed onto said memory stack;
construct an upgraded header according to said upgraded protocol; and
append said upgraded header to outbound data, wherein said at least one legacy parameter is proximate to said outbound data, thereby creating an outbound message of said fixed upgraded message length.

22. The stateless protocol method according to claim 21 wherein said processor is further programmed to:
receive said inbound message from an upper layer application having a data portion in an upper layer format; and
send said outbound message to a lower layer application.
